(19) United States
(12) Patent Application Publication
(10) Pub. No.: US 2003/0135784 A1
(43) Pub. Date: Jul. 17, 2003

(54) Multicast communication method and system

(76) Inventors: Takao Yamaguchi, Tokyo (JP); Tomoaki Itoh, Kanagawa (JP); Hiroshi Arakawa, Nara (JP)

Correspondence Address: HARNESS, DICKEY & PIERCE, P.L.C., P.O. BOX 828, BLOOMFIELD HILLS, MI, 48303, US

(21) Appl. No.: 10/341,108

(22) Filed: Jan. 13, 2003

(30) Foreign Application Priority Data
Jan. 15, 2002 (JP) 2002-005764

(51) Int. Cl. H04L 1/22

(52) U.S. Cl. 714/18

(57) ABSTRACT

In delivery of data from a sender terminal to a plurality of receiver terminals via a network, a data packet a certain receiver terminal has lost is recovered by retransmission from a neighboring receiver terminal. Each receiver terminal has a negative acknowledgement (NACK) timer and a retransmit packet timer. A retransmission control section determines a set value for these timers according to the number of times of retransmission, the network propagation delay time, the number of receiver terminals and the permissible delay time so that the delay time from detection of loss of a data packet until arrival of a retransmit packet falls within the permissible delay time that was determined with the capacity of a receiver buffer.

### BACKGROUND OF THE INVENTION

The present invention relates to a multicast communication method and system for attaining data delivery within a permissible time in the technology of multicasting media data (video data, audio data and the like) using the Internet, intranets and the like.

Applications of one-to-many communication, typified by Internet conferencing and live broadcasting, have become widespread. Multicasting is known as a technology for realizing such applications of one-to-many communication.

As one of protocols assuring the reliability of arrival of data packets to receivers in multicasting, Scalable Reliable Multicast (SRM) is known in which a missing packet is recovered by retransmission (see S. Floyd et al. “A Reliable Multicast Framework for Light-weight Sessions and Application Level Framing”, IEEE/ACM Transactions on Networking, Vol. 5, No. 6, December 1997). In SRM, retransmission is controlled based on a negative acknowledgement (NACK). This control generally causes the following problem. That is, a plurality of receiver terminals may send their NACKs for a data packet lost at a certain link on a network, resulting in a plurality of NACKs for the same data packet being returned to a sender terminal. Also, a plurality of retransmissions may be done in response to a same NACK. In both cases, the sender terminal is overloaded and this affects the transmission rate. The network is also overloaded because packets are sent in duplication. To overcome this problem, in SRM, the interval at which NACKs are sent from receiver terminals and the interval at which retransmit packets are sent from a sender terminal and neighboring receiver terminals are varied, to thereby avoid duplication of the NACKs and the retransmit packets.

To state more specifically, detection of loss of a data packet is made using sequence numbers. Once recognizing lack of a sequence number, a receiver terminal determines that a data packet corresponding to the sequence number is missing, The receiver terminal sets a NACK timer (request timer) for sending a NACK, and multicasts the NACK upon timeout of the NACK timer after the lapse of a predetermined wait time (t1). When a receiver terminal having received the data packet in question or the sender terminal receives the NACK, the receiver terminal or the sender terminal sets a retransmit packet timer (repair timer) for retransmitting the data packet, and re-multicasts the data packet upon timeout of the retransmit packet timer after the lapse of a predetermined wait time (t2) (retransmit processing). The time t1 is a uniform random number in the range of [C1d, (C1+C2)d], and the time t2 is a uniform random number in the range of [D1d, (D1+D2)d], where d is the one-way propagation delay time from the sender terminal to the receiver terminal, and C1, C2, D1 and D2 are retransmission parameters. Once a retransmit packet for a NACK has been sent, the other receiver terminals refrain from sending the retransmit packet for the same NACK. By operating in this manner, a receiver terminal having received the packet normally can send the retransmit packet to a neighboring receiver terminal. This permits reduction of the delay time from detection of packet loss until arrival of a retransmit packet.

In SRM described above, it is important to set appropriate values for the retransmission parameters C1, C2, D1 and D2. If these retransmission parameters are set so that the values t1 and t2 are small, the delay can be reduced but the load is high. On the contrary, if the retransmission parameters are set so that the values t1 and t2 are large, the load is low but the delay increases.

By adopting the conventional SRM technology described above, however, it is not assured that a retransmit packet arrives at a receiver terminal within a permissible time from the detection of packet loss. If a retransmit packet fails to arrive within a permissible time, real-time reproduction of media data will no more be continued, causing disturbance of an image or interruption of sound. This has been a technical problem to be overcome related to retransmission in the conventional multicast technology.

### SUMMARY OF THE INVENTION

An object of the present invention is attaining data delivery within a permissible time in multicasting of media data.

To attain the above object, according to the present invention, attention is paid to the fact that each receiver terminal performs several-second data buffering, that is, a several-second delay is permitted in each receiver terminal, in multicasting of media data. Retransmission parameters are determined based on this permitted delay time.

To state more specifically, according to the present invention, in delivery of data from a sender terminal to a plurality of receiver terminals via a network, a receiver terminal, which has detected loss of a data packet to be received, multicasts a NACK after the lapse of a predetermined time (t1) controlled by a first timer (NACK timer). Another receiver terminal, which has received the data packet normally and also received the NACK, multicasts a retransmit packet after the lapse of a predetermined time controlled by a second timer (retransmit packet timer). According to the present invention, the set value for the first timer or the second timer is determined according to the propagation delay time between the sender terminal and the plurality of receiver terminals and the number of receiver terminals, for example, so that the delay time from the detection of loss of the data packet until arrival of the retransmit packet falls within a permissible delay time. The set value for the first or second timer may be changed with the number of times of retransmission designated.

### BRIEF DESCRIPTION OF THE DRAWINGS

FIG. 1 is a conceptual view of an example of network topology to which a multicast communication method of the present invention is applicable.

FIG. 2 is a view demonstrating an example of determination of retransmission parameters in the multicast communication method of the present invention.

FIG. 3 is a view showing an example of the relationship between the total number of receiver terminals and the use bandwidth according to the present invention, together with those in two comparative examples.

FIG. 4 is a view of a distribution of the retransmit packet arrival rate with respect to the delay time from detection of packet loss until arrival of a retransmit packet in Comparative Example 2 shown in FIG. 3.

FIG. 5 is a view of examples of distribution of the retransmit packet arrival rate with respect to the delay time from detection of packet loss until arrival of a retransmit packet according to the present invention.

FIG. 6 is a block diagram of an example of a multicast communication system according to the present invention.

FIG. 7 is a flowchart showing the operation of each receiver terminal illustrated in FIG. 6.

### DESCRIPTION OF THE PREFERRED EMBODIMENTS

Hereinafter, a preferred embodiment of the present invention will be described with reference to the accompanying drawings.

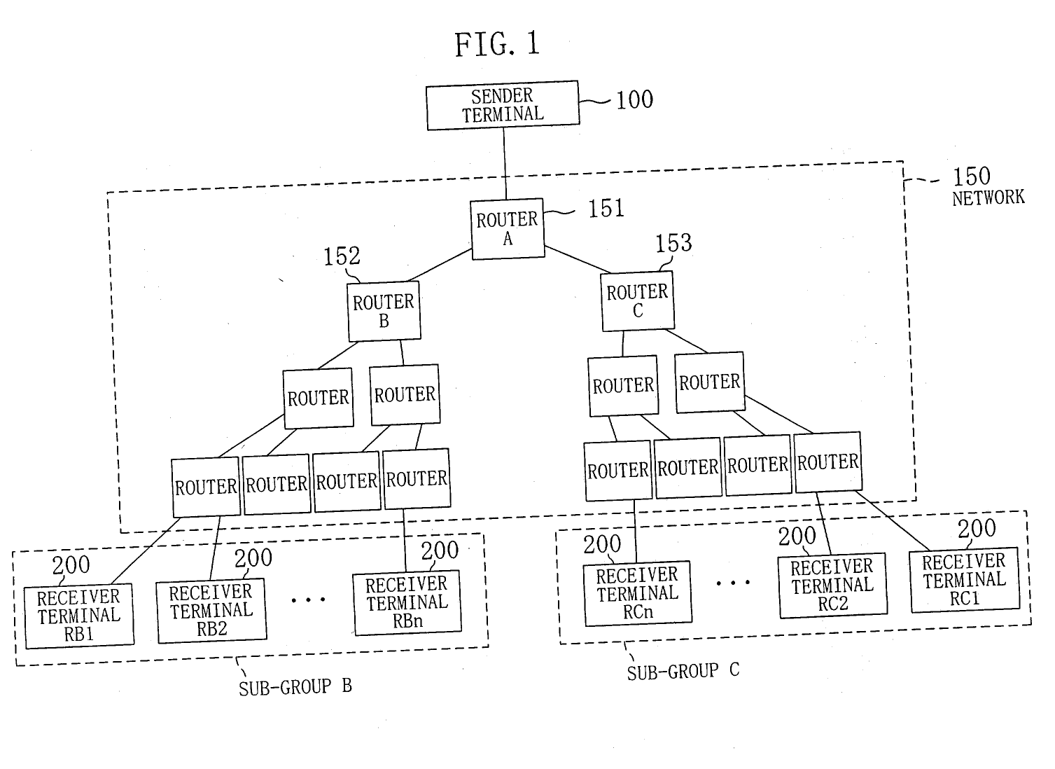

FIG. 1 shows an example of network topology to which the multicast communication method of the present invention is applicable. Referring to FIG. 1, media data is multicast from a sender terminal 100 to one group having N participant receiver terminals 200 (N is an integer) via a network 150. The network 150 has a four-level tree structure composed of two-branch routers, in which a first-level router A 151 is linked to the sender terminal 100, and second-level routers B 152 and C 153 are linked to the first-level router A. The router B is responsible for data delivery to a sub-group B via lower-level routers, and the router C is responsible for data delivery to a sub-group C via lower-level routers. The sub-groups B and C include n (=N/2) receiver terminals RB1 to RBn and RC1 to RCn, respectively. Assume that loss of a data packet may occur at any links in the levels lower than the router A.

Consider a one-way propagation delay time a (seconds) between the sender terminal 100 and the router A and a one-way propagation delay time d (seconds) between the sender terminal 100 and the farthest receiver terminal 200. Assuming that the interlink delay is 0.01 seconds, for example, the one-way propagation delay time from the sender terminal 100 to any of the receiver terminals 200 is 0.05 seconds, and thus a=0.01 seconds and d=0.05 seconds.

Under the conditions described above, suppose a data packet is lost at a link close to the receiver terminal RB1. In the SRM approach, the following steps are performed from detection of loss of the data packet by the receiver terminal RB1 until reception of a retransmit packet by the receiver terminal RB1:

(1) The receiver terminal RB1 detects loss of the data packet;

(2) The receiver terminal RB1 waits for a predetermined time [C1d];

(3) The receiver terminal RB1 sends a NACK after the lapse of a time of a uniform random number in the range of 0 to [C2d];

(4) The sent NACK arrives at the receiver terminals (RB2 to RBn and RC1 to RCn) that have received the data packet;

(5) The receiver terminals (RB2 to RBn and RC1 to RCn) having the data packet wait for a predetermined time [D1d] after reception of the NACK;

(6) The receiver terminals having the data packet set a retransmit packet timer with a uniform random number in the range of 0 to [D2d], and a receiver terminal (for example, RC1) of which the retransmit packet timer has reached a timeout earliest multicasts a retransmit packet; and

(7) The retransmit packet arrives at all the receiver terminals including the receiver terminal RB1.

The delay time from detection of loss of a data packet by the receiver terminal RB1 until reception of a retransmit packet by the receiver terminal RB1 can be represented by the processing delays in the steps (2) through (7) above.

The wait times in the steps (2) and (5) only increase the delay time in vain and do not affect the use bandwidth. They are therefore set at C1=D1=0. The delay time related to the steps (4) and (7), which varies with the position of the receiver terminal, is 2(d−a)=0.08 seconds at maximum.

As for the step (3), in general, all the receiver terminals that have lost a packet set their NACK timers with a uniform random number in the range of 0 to [C2d], and a receiver terminal that has reached a timeout earliest sends the NACK. The number of receiver terminals that set the NACK timer differs with the position at which the loss occurs (upstream or downstream). Therefore, if the value [C2d] is excessively large, a longer time is required until a NACK is sent. However, if the value [C2d] is excessively small, the traffic of the network 150 may possibly increase abruptly. It is therefore necessary to set the value [C2d] appropriately so that the wait time is within a permissible time and abrupt traffic increase is avoided.

As for the step (6), when loss of a data packet occurs in the sub-group B, the data packet naturally has arrived at the receiver terminals (RC1 to RCn) of the sub-group C. Therefore, at least the n receiver terminals (RC1 to RCn) can retransmit the data packet. The retransmittable receiver terminals (RC1 to RCn) set their retransmit packet timers with a uniform random number in the range of 0 to [D2d] to wait for a timeout, and a receiver terminal that reaches the timeout earliest sends a retransmit packet. Therefore, the time until the retransmit packet is sent is random. The probability that one retransmit packet timer does not reach a timeout until the p-th time fraction when [D2d] is equally divided into n time fractions is (n−p)/n. Therefore, the probability that all the retransmit packet timers of the n receiver terminals (RC1 to RCn) do not reach their timeouts until the p-th time fraction is {(n−p)/n}ⁿ, and thus the probability that any of the n retransmit packet timers reaches its timeout until the p-th time fraction is given by 1−{(n−p)/n}ⁿ. When n≧5 and p=4, any of the retransmit packet timers reaches its timeout with a probability of 98% or more. That is, by the time of 4/n×[D2d], any of the retransmit packet timers reaches its timeout at a probability of 98% or more.

According to the present invention, the delay time from detection of loss of a data packet by the receiver terminal 200 until reception of a retransmit packet by the receiver terminal 200, that is, the total of the processing delays in the steps (3), (4), (6) and (7) is set to be within a delay time b permitted in data buffering in the receiver terminal 200. That is, the following expression (1) is established.

[C2d]+2(d−a)+4/n×[D2d]+2(d−a)≦b (1)

Assuming that an appropriate fixed value [C2d]fix is selected, the maximum of [D2d] satisfying the inequality (1), that is, [D2d]max is given by

[D2d]max={b−4(d−a)−[C2d]fix}×(n/4) (2).

By selecting the [D2d]max as the retransmission parameter, it is possible to multicast media data within a permitted time while using the transmission bandwidth most efficiently.

In the equation (2), when a=0.01 seconds, b=2 seconds, d=0.05 seconds, and [C2d]fix=0.1 seconds,

[D2d]max=1.74×(n/4)=1.74×(N/8) (3)

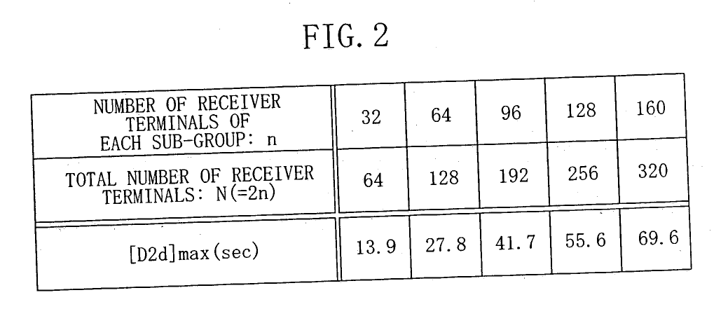

is given. According to the present invention, the set time for the retransmit packet timer is changed in direct proportion to the number n of receiver terminals in each sub-group or the total number N of receiver terminals, based on the equation (3), for example. FIG. 2 shows values of [D2d]max determined in this manner.

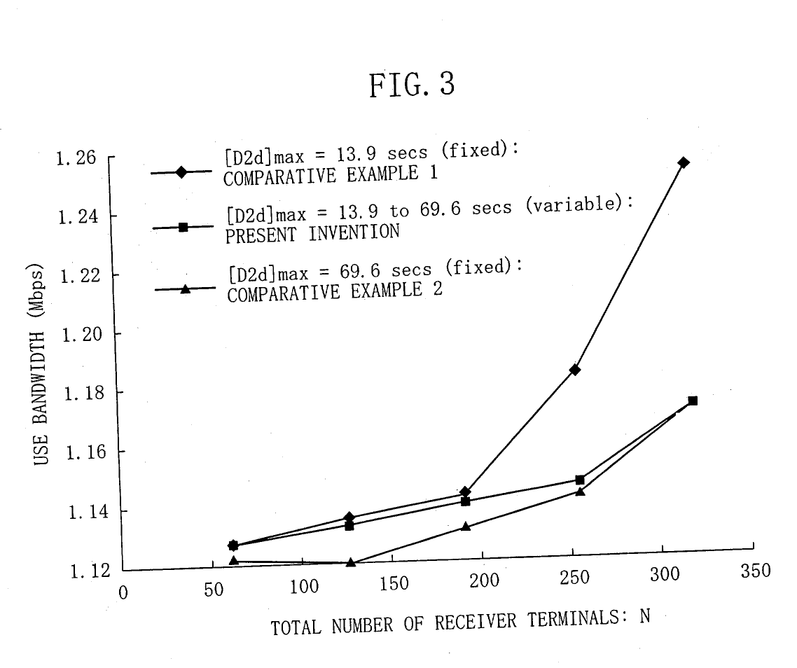

FIGS. 3, 4 and 5 show the simulation results. The value of [D2d]max was varied in the range of 13.9 seconds to 69.6 seconds with the total number N of receiver terminals as shown in FIG. 2 according to the present invention, while it was fixed at 13.9 seconds and 69.6 seconds in Comparative Examples 1 and 2, respectively. In the simulation, it was assumed that in the network topology shown in FIG. 1, loss of a data packet occurred independently at the link between the routers A and B and the link between the routers A and C, with a packet loss rate of 5% for each link. The bandwidth for the link between the sender terminal 100 and the router A was measured under the assumption that the inter-network link bandwidth was 10 Mbps and the transmission rate was 1 Mbps.

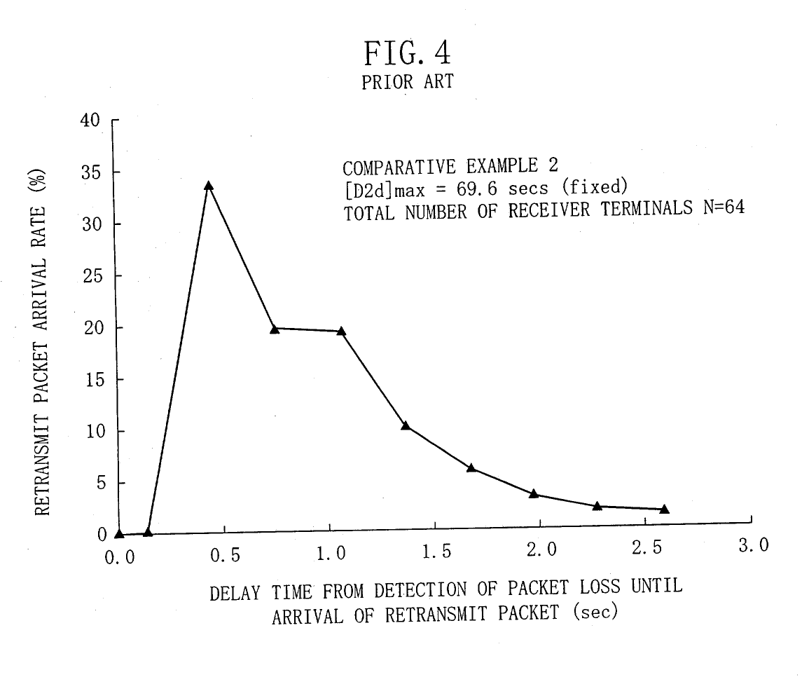

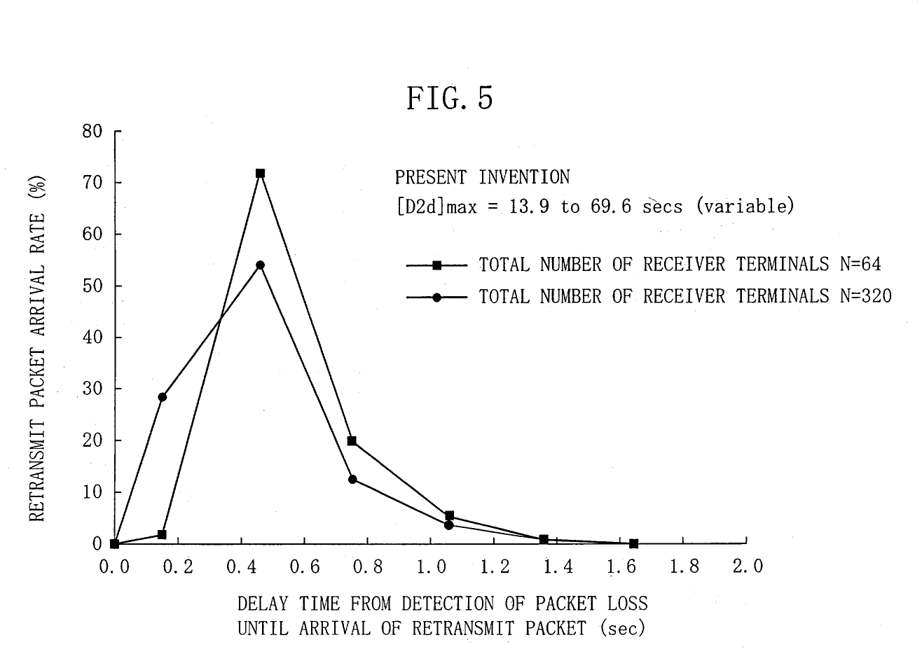

From FIG. 3, the following is found. The present invention, in which the value of [D2d]max is varied with the total number N of receiver terminals, is not so distinguished from Comparative Example 1 when the total number N of receiver terminals is small. However, with increase of the total number N of receiver terminals, the use bandwidth is prevented from increasing sharply according to the present invention, while it sharply increases in Comparative Example 1. This indicates that more efficient bandwidth use was established according to the present invention. In Comparative Example 2, the use bandwidth is lower than that according to the present invention. However, as is found from FIG. 4, the delay time until arrival of a retransmit packet exceeds 2 seconds, failing to satisfy the necessary condition. According to the present invention, as shown in FIG. 5, the delay time falls within 2 seconds for both the cases of the different total numbers N of receiver terminals. Thus, the approach of the present invention can satisfy the limitation of the delay time over the wide range of the total number N of receiver terminals while ensuring effective use of the transmission bandwidth, and in this way, secure real-time media transmission.

When the network topology is asymmetric, the number of receiver terminals of a smaller group may be set at n. The value d in this case may be the maximum of the propagation delay times between the sender terminal and a plurality of receiver terminals. The value d may otherwise be the average of the propagation delay times between the sender terminal and a plurality of receiver terminals. The number M of allowable retransmission times, which is 2 or more, may be designated. In this case, equations obtained by multiplying the right term of the equations (2) and (3) by 1/M may be used.

When loss of a data packet occurs in the sub-group B, the maximum n receiver terminals (RB1 to RBn) attempt to send their NACKs in the step (3) described above. Since these receiver terminals set their NACK timers with a uniform random number in the range of 0 to [C2d] to wait for a timeout, the time until a NACK is sent is random. When n≧5, any of the NACK timers reaches its timeout by the time of 4/n×[C2d] with a probability of 98% or more, for the reason described above in relation to the retransmit packet timer. Therefore, the following inequality (4) may be adopted in place of the inequality (1).

4/n×[C2d]+2(d−a)+[D2d]+2(d−a)≦b (4)

Assuming that an appropriate fixed value [D2d]fix is selected, the maximum of [C2d] satisfying the inequality (4), that is, [C2d]max is given by

[C2d]max={b−4(d−a)−[D2d]fix}×(n/4) (5).

By selecting the [C2d]max as the retransmission parameter, also, it is possible to multicast media data within a permitted time while using the transmission bandwidth most efficiently. Note however that the variable control of the parameter [D2d] of the retransmit packet timer is greater in control effect than the variable control of the parameter [C2d] of the NACK timer.

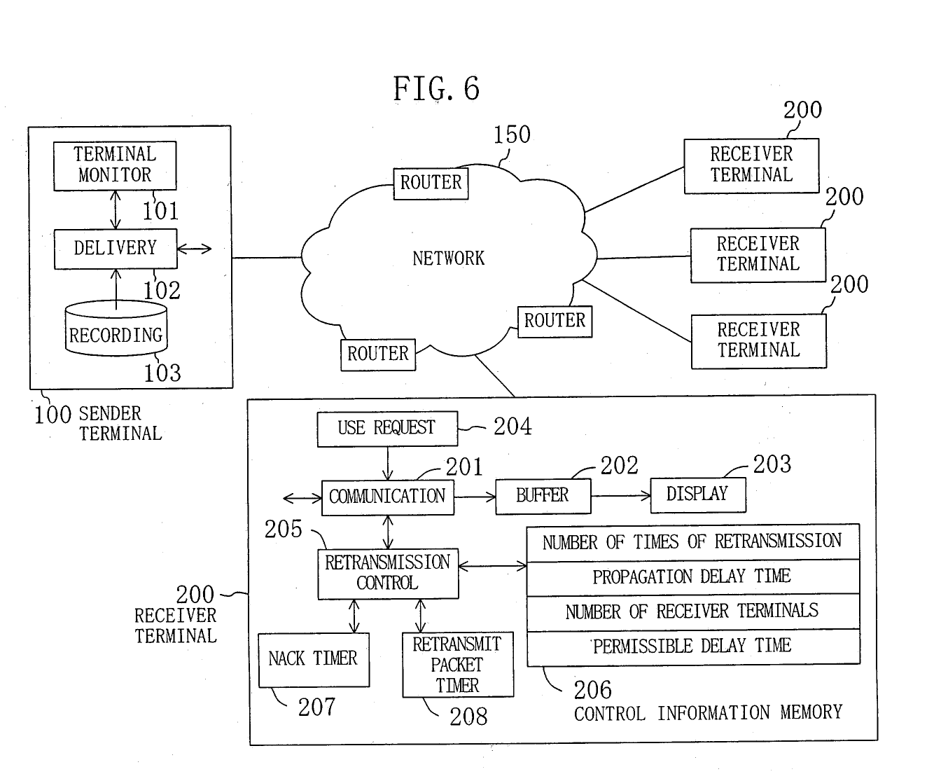

Hereinafter, a specific system configuration for implementing the multicast communication method of the present invention will be described. FIG. 6 shows an example of a multicast communication system of the present invention, in which a sender terminal 100 multicasts media data to a plurality of receiver terminals 200 via a network 150.

The sender terminal 100 in FIG. 6 includes a terminal monitor section 101 for managing the number of receiver terminals 200 joining a data delivery session, a delivery section 102 for delivering media data to the network 150, and a recording section 103 for recording media data to be delivered. Media data to be delivered may be coded in advance and then recorded in a recording medium such as a hard disk, or may be prepared by real-time coding. An arbitrary coding scheme may be adopted. The delivery section 102 not only delivers media data, but also has a function of multicasting a retransmit packet when a NACK is returned from any of the receiver terminals 200.

The network 150 shown in FIG. 6 includes a plurality of general routers each having a multicasting function. As the physical transmission route, a wired network (ISDN, ATM and the like) or a wireless network (cellular phones, wireless LAN and the like) may be used. Otherwise, a network constructed of mutually connected wired network and wireless network may be used.

Each of the receiver terminals 200 shown in FIG. 6 includes: a communication section 201 connected to the network 150; a buffer 202 for temporarily holding received media data; a display section 203 for displaying video data; a use request section 204 for making requests to join and leave a current session; a retransmission control section 205 for controlling retransmission according to the multicast communication method of the present invention; a control information memory 206 for storing control information used for determination of a retransmission parameter; a NACK timer 207; and a retransmit packet timer 208.

The control information memory 206 stores the number of times of retransmission, the propagation delay time, the number of receiver terminals and the permissible delay time. The number of times of retransmission may be explicitly determined by the users of the receiver terminals 200 and the manager of the sender terminal 100, or may be determined based on the permissible delay time and the like. The maximum or average of propagation delay times measured between the sender terminal 100 and the respective receiver terminals 200, for example, may be stored in the control information memory 206 as the propagation delay time commonly used in the entire network. For example, the propagation delay time may be measured when each receiver terminal 200 sends a request (use request) to join a current data delivery session to the sender terminal 100. Alternatively, the propagation delay times between the sender terminal 100 and the respective receiver terminals 200 may be measured at constant intervals. This measurement of the propagation delay times may be performed by the sender terminal 100 or by the respective receiver terminals 200. Otherwise, the measurement may be performed somewhere other than the sender terminal 100 or the receiver terminals 200. The propagation delay times between the sender terminal 100 and the respective receiver terminals 200 may be one-way or round-trip. When the network 150 is constructed of a wired network and a wireless network, the propagation delay time only in the segment of the wired network may be used because the wireless network includes a delay related to processing unique to the wireless network such as handover processing. Each of the receiver terminals 200 can acquire information on the number of receiver terminals managed by the terminal monitor section 101 of the sender terminal 100 and the propagation delay time measured/computed by the terminal monitor section 101 or the delivery section 102 of the sender terminal 100, for example, by sending inquiries about these information items to the sender terminal 100 at constant intervals. The permissible delay time is determined with the capacity of the buffer 202.

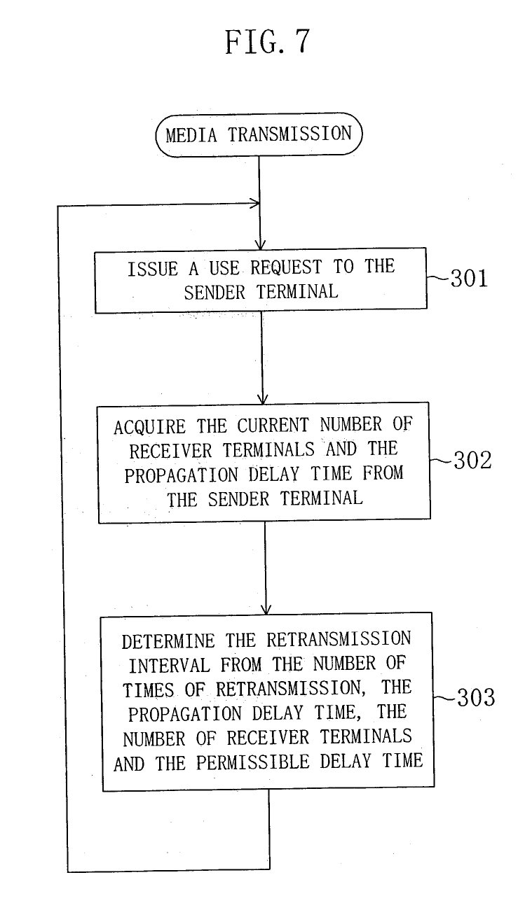

FIG. 7 shows the operation of each receiver terminal 200. The receiver terminal 200 issues a data use request to the sender terminal 100 (step 301). By receiving such data use requests, the terminal monitor section 101 of the sender terminal 100 can successively update the number of receiver terminals 200 joining the current data delivery session. Any receiver terminal 200 who no more wants to receive data notifies the sender terminal 100 of leaving the session, so that the terminal monitor section 101 can keep track of the increase/decrease of the number of receiver terminals. The receiver terminal 200 then acquires information on the current number of receiver terminals and the propagation delay time from the sender terminal 100 (step 302). The retransmission control section 205 of the receiver terminal 200 determines a retransmission parameter (retransmission interval) from the information stored in the control information memory 206, that is, the number of times of retransmission, the propagation delay time, the number of receiver terminals and the permissible delay time, according to the method described above, and provides the determined set value to the NACK timer 207 and the retransmit packet timer 208 (step 303).

By adopting the SRM retransmission control using the NACK timer 207 and the retransmit packet timer 208 set as described above, it is possible to multicast media data within a permissible time using general routers of the network 105. This ensures real-time reproduction of media data, and thus prevents occurrence of disturbance of an image or interruption of sound.

In FIG. 6, a plurality of sender terminals 100 may exist. The present invention is also applicable to parallel delivery of a plurality of media data items. SRM is not necessarily adopted, but any protocol that uses retransmission of a missing packet to keep the quality from degrading may be used.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention which fall within the true spirit and scope of the invention.

What is claimed is:

1. A multicast communication method for multicasting data from a sender terminal to a plurality of receiver terminals via a network, the method comprising steps of:
enabling a receiver terminal among the plurality of receiver terminals, having detected loss of a data packet to be received, to multicast a negative acknowledgement after a lapse of a predetermined time controlled by a first timer; and
enabling another receiver terminal among the plurality of receiver terminals, having received the data packet normally and also received the negative acknowledgement, to multicast a retransmit packet after a lapse of a predetermined time controlled by a second timer,
wherein the method further comprises a step of determining a timer set value for the first timer or the second timer so that the delay time from the detection of loss of the data packet until arrival of the retransmit packet falls within a permissible delay time.

2. The method of claim 1, wherein the step of determining a timer set value comprises a step of determining the set value according to a propagation delay time between the sender terminal and the plurality of receiver terminals and the number of receiver terminals.

3. The method of claim 1, wherein the step of determining a timer set value comprises a step of determining the set value according to the number of times of retransmission designated.

4. A multicast communication system for multicasting data from a sender terminal to a plurality of receiver terminals via a network, comprising:
means for enabling a receiver terminal among the plurality of receiver terminals, having detected loss of a data packet to be received, to multicast a negative acknowledgement after a lapse of a predetermined time controlled by a first timer; and
means for enabling another receiver terminal among the plurality of receiver terminals, having received the data packet normally and also received the negative acknowledgement, to multicast a retransmit packet after a lapse of a predetermined time controlled by a second timer,
wherein the system further comprises means for determining a timer set value for the first timer or the second timer so that the delay time from the detection of loss of the data packet until arrival of the retransmit packet falls within a permissible delay time.

5. The system of claim 4, wherein the means for determining a timer set value comprises means for determining the set value according to a propagation delay time between the sender terminal and the plurality of receiver terminals and the number of receiver terminals.

6. The system of claim 4, wherein the means for determining a timer set value comprises means for determining the set value according to the number of times of retransmission designated.
